(19) United States
(12) Patent Application Publication
(10) Pub. No.: US 2015/0168067 A1
(43) Pub. Date: Jun. 18, 2015

(54) METHOD FOR HEATING A METAL MATERIAL IN AN INDUSTRIAL FURNACE

(71) Applicant: RUDIGER EICHLER, Taby (SE)

(72) Inventor: RUDIGER EICHLER, Taby (SE)

(21) Appl. No.: 14/566,912

(22) Filed: Dec. 11, 2014

(30) Foreign Application Priority Data
Dec. 12, 2013 (EP) 130057938

(51) Int. Cl. F27B 9/12; F27B 9/36; F27B 9/30

(52) U.S. Cl. CPC F27B 9/12; F27B 9/3005; F27B 9/36; F27B 2009/122

(57) ABSTRACT

A method for heating a metal material in an industrial furnace includes a dark zone and at least one heating zone arranged downstream of the dark zone, the heating zone heated using at least one burner and the metal material is transported through the dark zone and thereafter through the heating zone, combustion gases circulate counter-currently through the furnace from the heating zone through the dark zone. A lambda value, ie a ratio of actual oxygen-to-fuel ratio and stoichiometric oxygen-to-fuel ratio of the combustion in at least one of the heating zones is below one, and an oxidant having at least 85 percent by weight of oxygen is supplied through at least one lance into the dark zone so that at least one stream of the oxidant is directed toward the metal material so that the oxidant in the dark zone combusts combustible gases originating from the heating zone.

The present invention relates to a method for heating metal material in an industrial furnace and a method for upgrading an air burner heated industrial furnace in order to increase the combustion efficiency.

Metal materials, such as slabs, billets and blooms, are conventionally heated in industrial furnaces which are heated using air burners, where combustion of a fuel takes place with air supplied by the burner. In counter-flow furnaces, the combustion products flow upstream in relation to the transport direction of the metal material, thereby heating the material which is approaching the air burners. In such furnaces, there is conventionally a so-called dark zone, in which loaded metal material is pre-heated by the counter-currently flowing combustion gases before entering the heating zone or zones of the furnace.

A problem is that air combustion is inefficient, since large volumes of nitrogen are heated in the process. It is therefore desirable to use high-oxygen oxidants to replace air in the above described furnaces.

It has for such furnaces been suggested to replace air burners with so-called oxyfuel burners, that is, burners fed with a high-oxygen oxidant rather than with air. However, in addition to such burners being expensive to install, this leads to smaller volumes of combustion products flowing through the furnace and the dark zone, and therefore that the loaded metal products are preheated less efficiently. In order to solve this problem, it has been proposed to lower the ceiling in the dark zone, thereby decreasing the volume of the dark zone and improving the preheating of the metal products therein per unit volume of combustion products. However, this leads to increased pressures in the main furnace space, downstream of the dark zone, increasing the risk of leaks therein.

Another possibility is to arrange additional burners in the dark zone. However, this has proven expensive and complicated, not least since many furnaces are quite broad and it is difficult to obtain even heating across the whole width of the metal products to be preheated without risking overheating of the metal material surface.

The present invention solves the above described problems.

Thus, the invention is a method for heating a metal material in an industrial furnace comprising a dark zone and at least one heating zone arranged downstream of the dark zone, which heating zone is heated using at least one burner, wherein said metal material is transported through the dark zone and thereafter through the heating zone, and wherein combustion gases circulate counter-currently through the industrial furnace through the at least one heating zone and thereafter through the dark zone, and is characterised in that the lambda value, in other words the ratio of the actual oxygen-to-fuel ratio and the stoichiometric oxygen-to-fuel ratio, of the combustion in said at least one heating zone is below one, and in that an oxidant comprising at least 85 percentages by weight oxygen is supplied through at least one lance into the dark zone, so that at least one stream of the said oxidant is directed towards the metal material and so that the said oxidant in the dark zone combusts combustible gases originating from the at least one heating zone.

In the following, the invention will be described in detail, with reference to exemplifying embodiments of the invention and to the appended drawings, where:

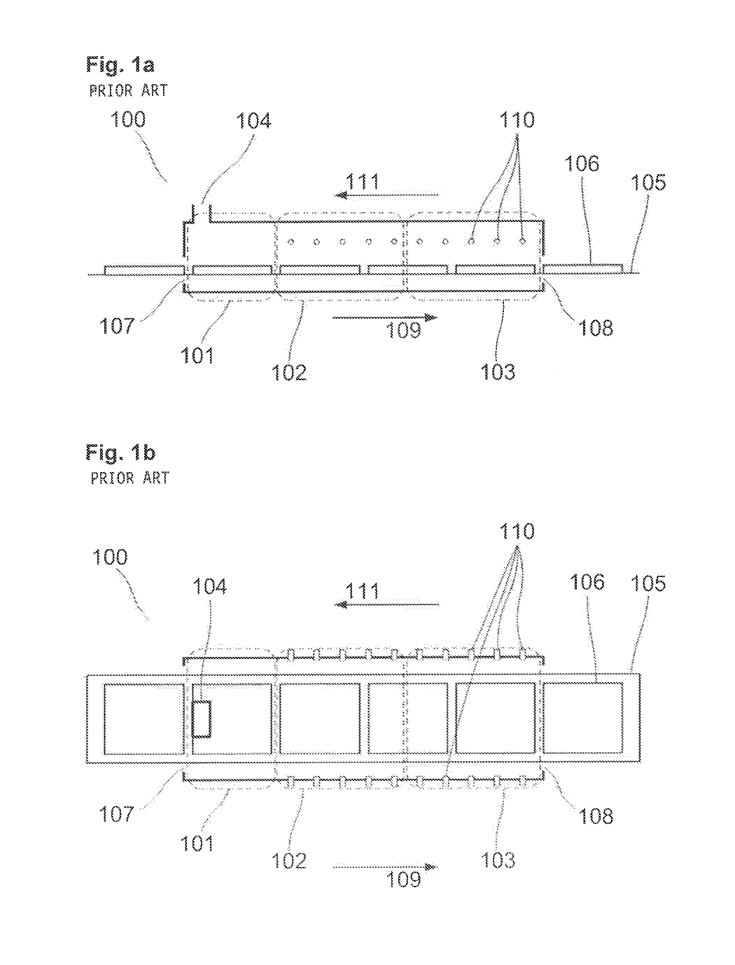

FIG. 1a is a simplified, partly removed side view of a conventional industrial furnace which is heated using air burners;

FIG. 1b is a simplified, partly removed top view of the furnace of FIG. 1a;

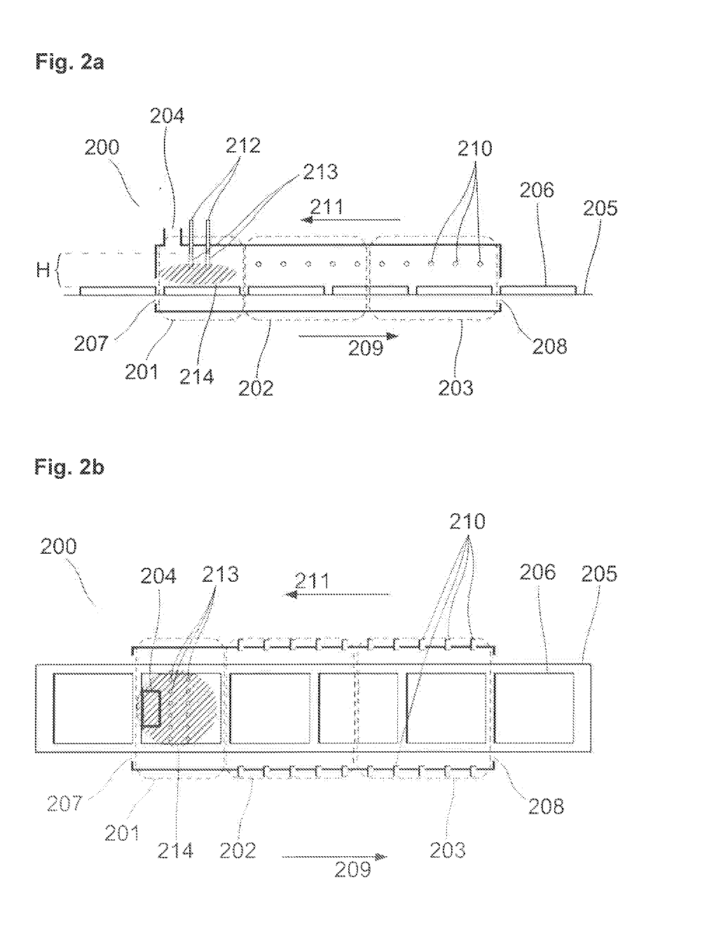

FIG. 2a is a simplified, partly removed side view of an industrial furnace arranged for operation using a method according to the present invention; and

FIG. 2b is a simplified, partly removed top view of the furnace of FIG. 2a.

FIGS. 1a and 1b show, using common reference numbers, an industrial furnace 100 which is heated by burners 110 and includes a dark zone 101 and two fired heating zones 102, 103. Hot combustion gases from burners 110 arranged in the zones 102, 103 circulate counter-currently through the furnace 100, in a general upstream direction 111, in order through the heating zone 103, through the heating zone 102 and thereafter through the dark zone 101, after which they escape through a flue or chimney 104. Burners 110 may be air burners, which is the preferred case in an upgrade according to below, but other burner types are also possible, including oxygen-assisted air burners or even burners driven directly with an oxidant comprising more oxygen than air. A mixture of such burners with air burners is also foreseeable. In the following, it is understood that burners 110 may be of such different types.

Metal material 106 to be heated is transported in a general downstream direction 109, opposite to the direction 111, on a transport device 105 such as a conveyor belt or the like (see below), from a loading point 107 to an exit point 108. It is preferred that the metal material is in the form of blanks, slabs or billets, and is preferably constituted by steel, preferably stainless steel, preferably a steel material displaying low emissivity, such as for example a steel material having a grinded surface. Namely, such steels are particularly suitable for use with the improved thermal energy transfer efficiency offered by the method of the present invention. The furnace 100 is preferably a walking beam furnace, a pusher furnace or an annular furnace, and the transport device 105 is thus of a suitable type for the type of furnace used.

Herein, the term “dark zone” is to be interpreted as a zone which preferably is arranged upstream, in relation to the travel direction 109 of the metal material 106, of any heating zone 102, 103 which is heated using one or several burners 110. Preferably, the dark zone 101 is arranged upstream, as seen in direction 109, of all fuel supply points in the industrial furnace 100. The dark zone 101 is arranged to preheat metal material 106 which has been loaded into the furnace 100 before reaching the first fired heating zone 102.

Both heating zones 102, 103 are thus heated using a series of burners 110 arranged along the side was of the furnace 100. Preferably, the burners are operated using a solid, liquid or gaseous fuel which is combusted with the supplied oxidant, such as aft, thus heating spaces 102, 103. The combustion products, comprising nitrogen, carbon dioxide, water etc., circulate counter-currently, in direction 111, through the furnace 100 upstream towards the exit 104.

It is realized that the furnace may comprise only one heating zone, or more than two heating zones.

FIGS. 2a and 2b show, with shared reference numbers, an industrial furnace 200 according to the present invention. That what has been said in relation to the furnace 100 is, in applicable cases, true also in relation to the furnace 200. Thus, similar to the furnace 100, the furnace 200 comprises a dark zone 201 and two heating zones 202, 203. Metal material 206 is transported, in a general direction 209, by a transport device 205 from a loading entry point 207 to an exit 208. Combustion gases, originating from a series of burners 210 arranged in the heating zones 202, 203, circulate counter-currently, in a general upstream direction 211, along the furnace 200 and are evacuated through a flue or chimney 204. Similar to burners 110, burners 210 are preferably air burners, most preferably only air burners, but may also be driven partly or completely, or be assisted, by an oxidant comprising more oxygen than air.

In the following, the differences between the conventional furnace 100 and the furnace 200 according to the invention will be described.

According to the invention, the lambda value of the combustion in at least one of the said heating zones 202, 203 is below one. The lambda value is the ratio of the actual oxygen-to-fuel ratio and the oxygen-to-fuel ratio when at stoichiometric equilibrium. In the conventional industrial furnace 100 of FIGS. 1a and 1b, the supply of oxygen and fuel to the burners 110 is balanced, so that combustion is performed at stoichiometric equilibrium. However, in contrast thereto, the supply of oxygen and/or fuel to the burners 210 which heat the zones 202, 203 of furnace 200 has been modified so that comparatively less oxygen is supplied in relation to the amount of supplied fuel. As a consequence, the resulting combustion gases circulating from the most upstream located heating zone 202 and into the dark zone 201 will carry a surplus of combustible gases. It is realized that such combustible gases may be in the form of non-combusted fuel gases and/or combustible gases in the form of CO, H₂ or the like, resulting from incomplete combustion of fuel in the heating zones 202, 203.

It is understood that in the preferred embodiment in which the burner 210 is an air burner, the lambda value of below one is achieved by decreasing the amount of air supplied to the air burner 210.

Furthermore, according to the invention, an oxidant comprising at least 85 percent by weight, preferably at least 95 percent by weight, preferably industrially pure, oxygen is supplied through at least one oxidant lance 212 arranged to open out into the dark zone 201. As a consequence, at least one stream 213 of the said high-oxygen oxidant is directed towards the metal material 206. Also, the high-oxygen oxidant will, in the dark zone 201, combust the above-described combustible surplus gases originating from the at least one upstream heating zone 202, 203.

It is preferred that the total combustion, counting combustion in all heating zones 202, 203 and the dark zone 201, will add up to stoichiometric equilibrium, or at least near stoichiometric equilibrium, so that essentially all fuel is combusted before the combustion products are evacuated through the flue 204.

By decreasing the amount of oxygen supplied through the burners, and replacing the decreased amounts of oxygen resulting from the smaller amounts of oxygen using the lanced high-oxygen oxidant in the dark zone, the nitrogen ballast decreases, which in turn increases the efficiency of the furnace 200. The additional combustion taking place as the lanced oxidant comes into contact with the combustible gases from the heating zones 202, 203 will result in a temperature increase in the dark zone. This solves the problem of low thermal transfer rates to the metal material 206 in the dark zone 201 when only replacing air burners 210 with oxyfuel burners, as discussed initially.

As the combustion in the dark zone 201 involves a lower-grade fuel (namely, diluted incomplete combustion products) than the combustion in the heating zones 202, 203, which involves the above described fuel directly, the flame temperature in the dark zone 201 will consequently also be lower. This leads to less NOₓ formation. As a result, the total NOₓ footprint of the process will be decreased as compared to the corresponding conventional case.

Moreover, since the high-oxygen oxidant is lanced towards the surface of the still relatively cold metal material 206, the extra heat is directed onto the surface, whereby the metal material will be efficiently preheated.

The fact that the surface of the metal material 206 is still relatively cold while still in the dark zone makes it less prone to overheating.

On the other hand, the lancing of the high-oxygen oxidant should preferably not result in said oxidant coming into direct contact with the metal material 206 surface. According to one preferred embodiment, the relation between on the one hand the amount of the oxygen lanced per time unit and per oxidant lance 212 in the lanced high-oxygen oxidant, and on the other hand the distance between the lance 212 orifice and the metal material 206, is such that the lanced oxidant mixes with the combustible gases present in the dark zone 201 before it strikes the surface of the metal material 206, and so that no unmixed oxidant comes into direct contact with the metal material 206. In other words, the amount of lanced oxygen is sufficiently small and the distance between the lance 212 orifice and the metal material 206 is sufficiently large so that the oxidant will mix with the combustible gases in the dark zone 201 sufficiently, so that essentially no un-mixed high-oxygen oxidant reaches the metal material 206 surface. It is preferred that the small amount of lanced oxygen and said large distance between lance orifice 212 and material 206 is to be established given a certain lancing velocity, which should be high (see below), and possibly also a given oxygen concentration in the lanced oxidant.

The distance H (FIG. 2a) between the lance 212 orifice and the metal material 206, as measured in the direction of the lance 212, is preferably at least 1.5 meters, more preferably at least 2 meters. In FIG. 2a, H indicates the vertical distance since the lance 212 is directed vertically. It is realized that if the lance is inclined, the distance H will be measured in a direction which is not vertical.

This way, the lancing action will push the high-temperature gases in the dark zone 201 towards the surface of the metal material 206 without risking overheating of the latter as a consequence. Instead, a “soft” flame can be arranged across a large portion of, or essentially the whole, width of the metal material 206, efficiently preheating the same while passing through the dark zone 201. In the Figures, the flame is illustrated by a combustion zone 214, throughout which the secondary combustion, between lanced oxidant and incompletely combusted gases, takes place.

To accomplish this, it is preferred that at least one row, preferably at least two essentially parallel rows, arranged essentially perpendicular to the direction 209, of high-oxygen oxidant lances 212 are arranged with at least three lances in each row, thus achieving an essentially uniform concentration of high-oxygen oxidant across the whole width, perpendicular to the direction 209, of the metal material 206.

It is especially preferred that at least one such lance 212 is arranged in the ceiling of the dark zone 201, and that the associated stream 213 of oxidant is directed essentially downwards towards the metal material 206 surface. However, the stream 213 may also be slightly inclined in the direction 209, such that the stream 213 is offset from the vertical towards the heating zone 202. Suitable angles are about 5-15° from the vertical. It is also realized that roof-mounted lances may be supplemented by lances mounted in the side walls of the dark zone 201, in order to achieve an even more uniform temperature profile of the gases surrounding the metal material 206.

Alternatively, the lances can be inclined so that the lanced high-oxygen oxidant propels the furnace gases in the downstream direction 209. This increases the turbulence, and hence increases the flame size, which in turn decreases the risk of overheating. In particular, such inclined lances may be useful in the downstream-most arranged part of the dark zone 201, in order to improve the mixing of the combustion products arriving from the heated zones 202, 203 with the lanced high-oxygen oxidant. Preferred lancing angles are in this case between 30° and 45° in relation to the vertical and inclined with the lance 212 orifice towards the downstream direction 209.

In order to avoid the risk of overheating the metal material 206 surface, it is preferred that only a minor part of the totally supplied oxygen originates from the lanced high-oxygen oxidant According to one preferred embodiment, the combustion power of the combustion reaction involving the lanced high-oxygen oxidant and the excess fuel supplied by burners 210 is at most about 10% of the total combustion power of the furnace 200. Thus, the total amount of supplied oxidant per unit time is small, preferably only between 1/10 and 1/100 of the volume, in comparison to the amount of combustion gases circulating through the dark zone 201 per unit time.

Furthermore, it is preferred the velocity of the oxidant at the orifice of the or each lance 212 is at least 100 m/s, more preferably between 300 m/s and 450 m/s. The combination of relatively small lanced volumes and high lancing velocities will produce a very high-turbulence, diluted, “soft” flame which is pushed downwards towards the surface of the metal material 206, efficiently preheating the same without risking overheating. It is preferred that about between 200-500 Nm³/h high-oxygen oxidant is provided through each lance.

According to a particularly preferred embodiment, a conventional furnace, such as the furnace 100, is upgraded for operation according to the present invention. In other words, an industrial furnace 100 which before the upgrade is arranged to be heated only by the use of one or several existing burners 110 and which comprises a dark zone 101 and at least one heating zone 102, 103 arranged downstream of the dark zone 101, which heating zone 102, 103 is arranged to be heated using said burners 110, wherein metal material 106 is transported through the dark zone 101 and thereafter through the heating zone 102, 103, and wherein combustion gases circulate counter-currently through the furnace 100 through the heating zones 103 and 102 and thereafter through the dark zone 101, is upgraded by supplementing it with at least one oxidant lance 212 arranged to supply a stream 213 of an oxidant comprising at least 85%, preferably at least 95%, preferably industrially pure, oxygen to the dark zone 101. Thereafter, the furnace 100 is operated as described above in connection with FIGS. 2a and 2b. Thus, the amount of oxygen supplied via the at least one burner 110 is decreased as compared to the operation before the upgrade, whereby the lambda value of the heating zones 102, 103 is decreased, and the resulting decrease in oxygen supply is compensated for by the lanced high-oxygen oxidant. Preferably, about 10%-50%, more preferably about 20%-30% of the total oxygen requirement of those burners which are operated in an oxygen-decreased state will be provided by the lanced high-oxygen oxidant.

It is understood that in the preferred embodiment in which at least one of the existing burners 110 is an existing air burner, that the decreased supplied oxygen amount is achieved by decreasing the amount of air supplied to the at least one existing air burner.

Such an upgrade is very cost efficient as compared to the replacement of some or all of the burners 110 with corresponding oxyfuel burners, and solves the initially discussed problems.

Since the total amounts of combustion gases escaping through the flue 204 will be less than before the upgrade at a given total combustion power, it is preferred that the amount of metal material 206 loaded per time unit during the operation is increased as compared to operation before the upgrade, so as to maintain essentially the same flue gas temperature at the flue gas exit 204 from the dark zone 201. In other words, the efficiency increase caused by the introduction of high-oxygen oxidant is preferably used to increase the production rate rather than to decrease the amount of fuel used.

Instead of, or in addition to, the above described decrease of the oxygen provided to the burners 210, the amount of the above described fuel provided to the heated zones 202, 203 per time unit can be increased in order to achieve the said lambda values below one.

Furthermore, it is preferred that the loading rate is adjusted so that the gas temperature at the exit 204 is kept at about 800°-900° C.

As an example, an air burner fired furnace with 3 heating zones On order of material transport direction Z1=20 MW, Z2=20 MW and Z3=5 MW) was upgraded according to the present invention by mounting high-oxygen oxidant lances in the roof of the dark zone.

After the upgrade, the most downstream arranged zones Z2 and Z3 were fired in a conventional manner with 26819 Nm³/h air and 2457 Nm³/h natural gas (total combustion power 25 MW). The resulting combustion products had the following composition:

| Exhaust gas composition | %-wet | Nm³/h |
|---|---|---|
| CO₂ | 8.7 | 2568 |
| H₂O | 16.7 | 4915 |
| SO₂ | 0.0 | 0 |
| O₂ | 2.0 | 587 |
| N₂ | 72.6 | 21310 |

In contrast to zones Z2 and Z3, the originally 20 MW zone Z1 was fired with an oxygen deficit, so that only 18 MW was combusted with air supplied via the existing air burners. 1966 Nm³/h natural gas was combusted with 17745 Nm³/h air. The combustion gases resulting from this combustion, with lambda=0,924, in zone Z1 had the following composition:

| Exhaust gas composition | %-wet | Nm³/h |
|---|---|---|
| CO₂ | 8.6 | 1725 |
| H₂O | 18.2 | 3650 |
| SO₂ | 0.0 | 0 |
| O₂ | 0.0 | 0 |
| H₂ | 1.4 | 282 |
| CO | 1.64 | 329 |
| N₂ | 70.2 | 14113 |

The resulting content of incompletely combusted, combustible gases (CO and H₂) corresponds to 2 MW, which was combusted using 320 Nm³/h lanced industrially pure oxygen in the dark zone. The final, total combustion products composition was:

| Exhaust gas composition | %-wet | Nm³/h |
|---|---|---|
| CO₂ | 9.3 | 4622 |
| H₂O | 17.9 | 8847 |
| SO₂ | 0.0 | 0 |
| O₂ | 1.2 | 601 |
| N₂ | 71.6 | 35423 |

Above, preferred embodiments have been described. However, it is apparent to the skilled person that many modifications may be made to the described embodiments without departing from the idea of the invention,

As an example, the introduction of high-oxygen oxidant lances in the dark zone also results in increased control over the temperature profile along the length of the furnace. In case several rows of such lances are installed, the amount of lanced high-oxygen oxidant via each such row may be adjusted depending on the desired temperature profile. Also, the proportion of the total oxygen supplied via lancing may be adjusted during operation or between batches, depending on the desired preheating in the dark zone.

Thus, the invention she not be limited to the described embodiments, but may be varied within the scope of the enclosed claims.

What is claimed is:

1. A method of heating a metal material (206) in an industrial furnace (200) including a dark zone (201) and at least one heating zone (202,303) arranged downstream of the dark zone and the dark zone is arranged upstream of a fuel supply in the industrial furnace, comprising:
heating the at least one heating zone with at least one burner;
transporting said metal material through the dark zone and thereafter through the at least one heating zone;
circulating combustion gases in a counter-current direction within the furnace through the at least one heating zone and therafter through the dark zone;
providing combustion in the at least one heating zone with a lambda value of a ratio of actual oxygen-to-fuel ratio and stoichiometric oxygen-to-fuel ratio below one;
supplying an oxidant comprising at least 85% by weight oxygen through at least one lance (212) into the dark zone;
directing at least one stream (213) of the oxidant toward the metal material in the dark zone; and
combusting said oxidant with combustion gases in the dark zone, said combustion gases originating from the at least one heating zone.

2. The method of claim 1, wherein said at least one burner (210) comprises an air burner, and further comprising decreasing an amount of air supplied to the air burner for achieving said lambda value below one.

3. The method of claim 1, comprising arranging the at least one lance (212) in a ceiling of the dark zone (201), and directing said at least one stream (213) of oxidant downward toward the metal material (206).

4. The method of claim 1, wherein the combustion power of combustion of the oxidant and excess fuel provided in the at least one heating zone is at most about 10% of total combustion power of the industrial furnace.

5. The method of claim 1, wherein the industrial furnace comprises a furnace selected from the group consisting of a walking beam furnace, a pusher furnace, and an annular furnace

6. The method of claim 1, wherein a relation between an amount of oxygen lanced per time unit and per the at least one oxidant lance (212) in the oxidant, and a distance between an orifice of each lance (212) and the metal material, (206) is such that for a given lancing velocity, comprises mixing the oxidant with the combustible gases present in the dark zone (201) before said oxidant contacts the surface of the metal material (206) wherein substantially no unmixed oxidant directly contacts the metal material (206).

7. The method of claim 6, wherein a distance (H) between the orifice of the at least one lance (212) and the metal material (206) as measured in a direction of lancing is at least 2 meters.

8. The method of claim 6, wherein the lancing velocity of the oxidant at the orifice of the at least one lance (212) is at least 100 m/s.

9. The method of claim 8, wherein the lancing velocity of the oxidant at the orifice of the at least one lance (212) is between 300 m/s and 450 m/s.

10. The method of claim 1, wherein the oxidant comprises at least 95 percent oxygen.

11. In a method of upgrading an existing industrial furnace (100) for a metal material (106) including a dark zone (101) and at least one heating zone (102,103) arranged downstream of the dark zone, at least one existing burner (110) for heating the at least one heating zone, a conveyor for conveying the metal material through the dark zone to the at least one heating zone, and combustion gases in the furnace circulate counter-currently through the at least one heating zone to the dark zone, the improvement comprising:
supplying a stream of oxidant comprising at least 85% oxygen to the dark zone by at least one oxidant lance (212);
decreasing an amount of oxygen supplied by the at least one burner (110) as compared to the oxygen supplied before said upgrading; and
compensating for the decreasing an amount of oxygen with the supplying a stream (213) of oxidant from the at least one oxidant lance.

12. The method of claim 11, wherein at least one of the at least one existing burner (110) comprises an existing air burner, and the decreasing supplied oxygen amount is achieved by decreasing an amount of air supplied to the at least one existing burner.

13. The method of claim 11, further comprising increasing an amount of the metal material loaded per time unit during the furnace operation compared to the furnace operation before the upgrading, and substantially maintaining a similar flue gas temperature at a flue gas exit (104) of the dark zone (101).

14. The method of claim 11, further comprising arranging the at least one oxidant lance (212) in a ceiling of the dark zone (101), and directing the stream (213) of said oxidant downward toward the metal material (106).
